(19) United States
(12) Patent Application Publication
(10) Pub. No.: US 2016/0260132 A1
(43) Pub. Date: Sep. 8, 2016

(54) ADVERTISEMENT SERVICE SYSTEM AND METHOD THEREOF, AND APPARATUS APPLIED TO THE SAME

(71) Applicant: SK PLANET CO., LTD., Seongnam-si, Gyeonggi-do (KR)

(72) Inventor: Min Ho HAN, Seoul (KR)

(21) Appl. No.: 14/778,035

(22) PCT Filed: Dec. 26, 2013
(86) PCT No.: PCT/KR2013/012221

§ 371 Date: Sep. 17, 2015

(30) Foreign Application Priority Data
Apr. 3, 2013 (KR) 10-2013-0036258

(51) Int. Cl. G06Q 30/02

(52) U.S. Cl. CPC G06Q 30/0258

(57) ABSTRACT

The present invention discloses an advertisement service system, a method therefor, and an apparatus applied to the same which acknowledge a registration amount for an advertisement which is requested to be registered, register, for each of a specific number of terminals according to the registration amount among a plurality of terminals where at least two applications, which are registration targets for the advertisement, are respectively installed, the advertisement for one application of the at least two applications, and provide the advertisement to respective applications according to the registration result, such that the same advertisement is not provided to one terminal even when many applications, which are regarded as a population parameter (advertisement target), are installed on one terminal.

### TECHNICAL FIELD

The present invention relates to an advertisement service which provides an advertisement using an application installed on a terminal as a population parameter (advertisement target) and, more specifically, to an advertisement providing system, a method therefor, and an apparatus applied to the same which prevent the same advertisement from being provided to one terminal multiple times.

### BACKGROUND ART

Recently, high-performance terminals such as smartphones are commonly used thanks to the development in mobile communication technologies and devices, and various services can be used on these high-performance devices by installing various applications on them.

Based on this environment, a push type advertisement service has emerged which provides advertisements using applications as population parameters (advertisement targets).

This advertisement service registers/manages advertisements by using applications as population parameters, and provides the advertisement to the terminals where applications for which advertisements are registered are installed, when an advertisement provision event for the advertisement occurs, such that the advertisement is exposed on the corresponding application of the terminal.

By the way, since the conventional advertisement service uses the application as the population parameter, it can happen that the same advertisement is provided to one terminal multiple times. For example, when advertisement 1 is registered/managed by using application a and application b as population parameters and both the application a and application b are installed on terminal 1, the same advertisement 1, which is registered by using application a and application b as population parameters, can be provided to terminal 1 two times.

In this case, an unpleasant feeling is caused since a user of the terminal has to view the same advertisement more than once, and the effect of the advertisement is decreased since it is beneficial for an advertiser to expose the advertisement to as many people as possible.

Therefore, the present invention propose an advertisement service for providing advertisements using applications installed on terminals as population parameters (advertisement targets) which prevents the same advertisement from being exposed on one terminal even when multiples applications, which are treated as the same population parameter (advertisement target), are installed on one terminal.

### DISCLOSURE OF THE INVENTION

The present invention is envisioned by considering the aforementioned situations, and an object of the present invention is to register the advertisement in such a way that the same advertisement is not provided to one terminal during an advertisement registration process for registering advertisements using applications as the population parameters, such that the same advertisement is prevented from being provided multiple times even when multiple applications, which are treated as the same population parameter, are installed on one terminal.

In order to accomplish the object, an advertisement providing apparatus according to a first aspect of the present invention is characterized in comprising: a registration amount acknowledgment unit which acknowledges a registration amount for an advertisement which is requested to be registered; an advertisement registration unit which, for each of a specific number of terminals according to the registration amount among a plurality of terminals where at least two applications, which are registration targets for the advertisement, are respectively installed, registers the advertisement for one application of the at least two applications; and an advertisement providing unit which provides the advertisement to respective applications according to a registration result of the advertisement registration unit, such that the advertisement can be exposed on only one of the applications which are installed on each of the specific number of terminals.

More particularly, the registration amount for the advertisement is characterized in being determined based on an advertisement quantity set for the advertisement and an advertisement provision frequency for respective advertisement periods set for the advertisement.

More particularly, the advertisement registration unit is characterized in acknowledging the specific number of terminals according to the registration amount among the plurality of terminals, and, for each of the specific number of acknowledged terminals, registering the advertisement for one application, for which no advertisement is registered, among the at least two applications installed on the terminal.

In order to accomplish the object, an advertisement providing apparatus according to a second aspect of the present invention is characterized in comprising: a registration amount acknowledgment unit which acknowledges a registration amount for an advertisement which is requested to be registered; a linked list storage unit which stores a terminal information linked list in which terminal information on each of a plurality of terminals are listed; and an advertisement registration unit which acknowledges a specific number of terminals according to the registration amount among a plurality of terminals where at least two applications, which are registration targets for the advertisement, are respectively installed, and, for each of the specific number of acknowledged terminals, registers the advertisement for one application, for which no advertisement is registered, among the at least two applications installed on the terminal, wherein the advertisement registration unit sequentially acknowledges the specific number of pieces of terminal information according to the registration amount in a forward sequence from first terminal information listed in the terminal information linked list or sequentially acknowledges the specific number of pieces of terminal information according to the registration amount in a reverse sequence from latest listed terminal information, such that the specific number of terminals are acknowledged among the plurality of terminals.

More particularly, the respective terminal information is characterized in including pointing information which points to one application, for which no advertisement is registered, among the at least two applications installed on the corresponding terminal, and the advertisement registration unit is characterized in registering the advertisement for the one application according to the pointing information of the respective sequentially-acknowledged terminal information while acknowledging the specific number of pieces of terminal information in the terminal information linked list.

More particularly, the advertisement which is requested to be registered is characterized in including a first advertisement and a second advertisement, and the advertisement registration unit is characterized in acknowledging, for the first advertisement, the specific number of the terminals according to the registration amount of the first advertisement by using one of the forward sequence and the reverse sequence based on the terminal information linked list, and, acknowledging, for the second advertisement, the specific number of the terminals according to the registration amount of the second advertisement by using the other of the forward sequence and the reverse sequence different from the one for the first advertisement based on the terminal information linked list.

More particularly, the linked list storage unit is characterized in registering, for each of the plurality of terminals, an application information linked list in which application information on each of the at least two applications installed on the corresponding terminal is listed, and the pointing information included in the terminal information of a specific terminal among the plurality of terminals is characterized in pointing to application information on an application for which no advertisement is registered and which is listed first in the application information linked list for the specific terminal.

In order to accomplish the object, an advertisement service method according to a third aspect of the present invention is characterized in comprising: a step in which an advertisement providing apparatus acknowledges a registration amount for an advertisement which is requested to be registered; a step in which the advertisement providing apparatus, for each of a specific number of terminals according to the registration amount among a plurality of terminals where at least two applications, which are registration targets for the advertisement, are respectively installed, registers the advertisement for one application of the at least two applications; a step in which the advertisement providing apparatus provides the advertisement to respective applications according to a registration result; and a step in which the one application, which is installed on each of the specific number of terminals, exposes the provided advertisement.

In order to accomplish the object, an operating method of an advertisement providing apparatus according to a fourth aspect of the present invention is characterized in comprising: a registration amount acknowledgment step in which a registration amount for an advertisement which is requested to be registered is acknowledged; an advertisement registration step in which, for each of a specific number of terminals according to the registration amount among a plurality of terminals where at least two applications, which are registration targets for the advertisement, are respectively installed, the advertisement is registered for one application of the at least two applications; and an advertisement providing step in which the advertisement is provided to respective applications according to a registration result of the advertisement registration step, such that the advertisement can be exposed on only one of the applications which are installed on each of the specific number of terminals.

More particularly, the advertisement registration step is characterized in including: a first step in which the specific number of terminals are acknowledged among the plurality of terminals according to the registration amount; and a second step in which, for each of the specific number of acknowledged terminals, the advertisement is registered for one application, for which no advertisement is registered, among the at least two applications installed on the terminal.

More particularly, the method is characterized in further comprising a step in which a terminal information linked list in which respective terminal information on each of a plurality of terminals is listed is stored, and in the first step, the specific number of pieces of terminal information according to the registration amount in a forward sequence from first terminal information listed in the terminal information linked list are sequentially acknowledged or the specific number of pieces of terminal information according to the registration amount in a reverse sequence from latest listed terminal information are sequentially acknowledged, such that the specific number of terminals are acknowledged among the plurality of terminals.

More particularly, the method is characterized in further comprising a step in which a terminal information linked list in which respective terminal information on each of the plurality of terminals is listed and, for each of the plurality of terminals, an application information linked list in which application information on each of the at least two applications installed on the corresponding terminal is listed are stored, wherein the respective terminal information includes pointing information pointing to application information on an application for which no advertisement is registered and which is listed first in the application information linked list for the specific terminal; and in the second step, the advertisement is registered for the one application according to the pointing information of the respective terminal information which is sequentially acknowledged in the first step while sequentially acknowledging the specific number of pieces of terminal information from the terminal information linked list$1

In order to accomplish the object, an advertisement service system according to a fifth aspect of the present invention is characterized in comprising: an advertisement providing apparatus which acknowledges a registration amount for an advertisement which is requested to be registered, registers, for each of a specific number of terminals according to the registration amount among a plurality of terminals where at least two applications, which are registration targets for the advertisement, are respectively installed, for one application of at least two applications, and provides the advertisement to the respective applications according to a registration result; and a terminal on which the at least two applications are installed and which exposes the advertisement provided from the advertisement providing apparatus through the one application of the at least two applications.

In the meantime, by using advertisement service system and the method therefor, and the apparatus applied to the same, advertisements are registered in such a way that the same advertisement is not provided to one terminal multiple times during an advertisement registration process during which the advertisements are registered using applications as population parameters, and, therefore, when the advertisements are provided according to a registration result, there is obtained an effect that the advertisement service is provided such that the same advertisement is not provided more than once even when more than one application, which is treated as the same population parameter, is installed on one terminal.

### BRIEF DESCRIPTION OF THE DRAWINGS

FIG. 1 is a block diagram showing an advertisement service system according to one embodiment of the invention.

FIG. 2 is a block diagram showing a configuration of an advertisement providing apparatus according to an embodiment of the present invention.

FIG. 3 is a flow chart showing a control flow of an advertisement service method according to one embodiment of the invention.

FIG. 4 is an operation flow chart showing an operation method for an advertisement providing apparatus according to an embodiment of the present invention.

FIG. 5 is an illustration depicting a data structure based on a terminal information linked list and an application information linked list in the advertisement providing apparatus according to an embodiment of the present invention.

### BEST MODE FOR CARRING OUT THE INVENTION

Here, one embodiment of the present invention is described by referring to the appended figures.

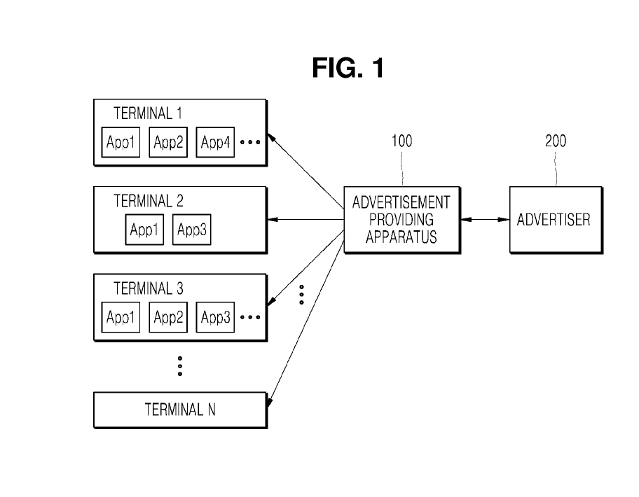

FIG. 1 is a diagram illustrating an advertisement service system according to an embodiment of the present invention.

As shown in FIG. 1, the advertisement service system according to the present invention can comprise a plurality of terminals, an advertisement providing apparatus 100, and an advertiser 200.

Here, the terminals can include terminal 1, terminal 2, terminal 3 . . . terminal N, as shown in FIG. 1.

Each of the terminals is a terminal device where at least two applications are installed to provide various services, and can be smartphones, for example.

In the following, it is assumed that application 1 (App1, hereinunder), application 2 (App2, hereinunder), application 4 (App4, hereinunder) . . . are installed on terminal 1, App1 and application 3 (App3, hereinunder) are installed on terminal 2, and App1, App2, App3 . . . are installed on terminal 3 for the convenience of explanation.

The advertisement providing apparatus 100 is an apparatus which provides the advertisement service by providing the advertisements using the applications installed on a terminal as advertisement targets (population parameters).

That is, the advertisement providing apparatus 100 registers/manages advertisements by treating applications as population parameters, and provides the advertisement to the terminals where applications for which advertisements are registered are installed, when an advertisement provision event for the advertisement occurs, such that the advertisement is exposed on the corresponding application of the terminal. In the meantime, the advertisement providing apparatus 100 can provide the advertisements by utilizing various conventional push type providing methods.

The advertisement providing apparatus 100 according to the present invention as above provides the advertisement service while preventing the same advertisement from being provided to one terminal during the advertisement service.

More particularly, the advertisement providing apparatus 100 registers the advertisements in such a way that the same advertisement is not provided to one terminal multiple times during the advertisement registration process during which the advertisements are registered for the applications as population parameters, and, therefore, when the advertisements are provided according to a registration result, can achieve an effect that the advertisement service is provided such that the same advertisement is not provided more than once even when more than one application, which is treated as the same population parameter, is installed on one terminal.

That is, when the advertisement providing apparatus 100 according to the present invention is described, the advertisement providing apparatus 100 acknowledges a registration amount for an advertisement which is requested to be registered, registers, for each of a specific number of terminals according to the registration amount among a plurality of terminals where at least two applications, which are registration targets for the advertisement, are respectively installed, the advertisement for one application of at least two applications, and provides the advertisement to respective applications according to a registration result.

That is, when describing an advertisement registration process during which the advertisement providing apparatus 100 registers the advertisement for the applications as the population parameters, the advertisement providing apparatus 100 acknowledges the registration amount for the advertisement associated with the advertisement which is requested to be registered by the advertiser 200.

Here, as the registration requests for the advertisements, there can be an instant registration request, and a reserved registration request.

Therefore, the advertisement providing apparatus 100 can instantly perform the advertisement registration process when the instant registration is requested from the advertiser 200, and perform the advertisement registration process at the timing according to a reserved registration request, when the reserved registration for the advertisement is requested from the advertiser 200.

Here, when the registration of an advertisement is requested from the advertiser 200, the advertisement providing apparatus 100 acknowledges the registration amount for the advertisement (e.g.: advertisement 1) according to the registration request. In the following, the description will refer to the advertisement 1 which is requested to be registered for the convenience of explanation.

Then, the advertisement providing apparatus 100 registers, for each of a specific number of terminals according to the acknowledged registration amount among a plurality of terminals (terminal 1, terminal 2, terminal 3 . . . terminal N) where at least two applications, which are registration targets for the advertisement 1, are respectively installed, the advertisement for one application of at least two applications.

That is, the advertisement providing apparatus 100 acknowledges the specific number (e.g.: 10) of terminals according to the acknowledged registration amount among the terminals (terminal 1, terminal 2, terminal 3 . . . terminal N) where at least two applications, which are registration targets for the advertisement 1, are respectively installed.

And, the advertisement providing apparatus 100 registers the advertisement only for one application of the at least two applications installed on the terminal, for each of the acknowledged specific number of (e.g.: 10) terminals.

Again, when at least two applications, which are registration targets for the advertisement 1, are installed on each of the acknowledged specific number (e.g.: 10) of terminals, the advertisement providing apparatus 100 registers the advertisement for the application as the population parameter such that the same advertisement is not provided to one terminal more than once by registering the advertisement 1 for only one application of the at least two applications installed on the corresponding terminal for each of the specific number (e.g.: 10) of terminals.

Also, the advertisement providing apparatus 100 can expose the advertisement 1 on only one application installed on each of the specific number (e.g.: 10) of terminals by registering the advertisement 1 for the application as the population parameter and providing the advertisement 1 to the respective applications according to the registration result, as described above.

That is, the advertisement providing apparatus 100 can provide the advertisement 1 to respective applications according to the registration result when an advertisement provision event for the advertisement 1 occurs after the advertisement 1 is registered for the respective applications as population parameters, as described above.

Therefore, the advertisement 1 is exposed through the corresponding applications on the specific number (e.g.: 10) of terminals where the one application, which has received advertisement 1 provided from the advertisement providing apparatus 100, is installed among the plurality of terminals, that is, terminal 1, terminal 2, terminal 3 . . . terminal N.

As a result, in the advertisement service system according to the present invention, the advertisement 1 is registered for only one application on each of the specific number (e.g.: 10) of terminals according to the registration amount (e.g.: 10) for the advertisement 1, and the advertisement 1 is provided according to the registration result, thereby preventing the same advertisement from being provided to one terminal more than once in providing the advertisement service, as described above.

Meanwhile, the aforementioned population parameter, the advertisement target, and the registration target all refer to the application which receives and exposes the advertisement, and the population parameter, the advertisement target, and the registration target are interchangeably used for the convenience of explanation in the following.

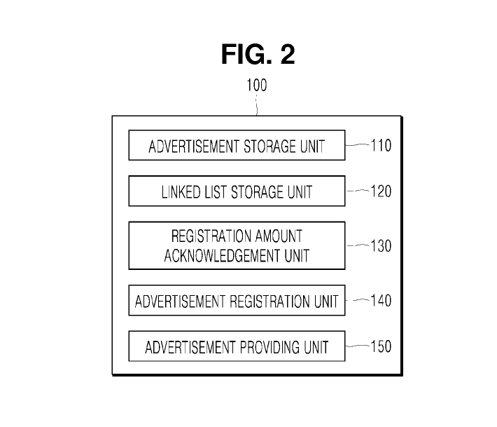

In the following, the configuration of the advertisement providing apparatus according to one embodiment of the present invention is described in more detail by referring to FIG. 2.

The advertisement providing apparatus 100 according to a first aspect of the present invention comprises a registration amount acknowledgment unit 130 which acknowledges a registration amount for an advertisement which is requested to be registered, an advertisement registration unit 140 which, for each of a specific number of terminals according to the registration amount among a plurality of terminals where at least two applications, which are registration targets for the advertisement, are respectively installed, registers the advertisement for one application of the at least two applications, and an advertisement providing unit 150 which provides the advertisement to respective applications according to a registration result of the advertisement registration unit 140, such that the advertisement can be exposed on only one of the applications which are installed on each of the specific number of terminals.

The registration amount acknowledgment unit 130 acknowledges a registration amount for an advertisement which is requested to be registered.

Here, the registration amount for the advertisement can be determined based on an advertisement quantity set for the advertisement and an advertisement provision frequency for respective advertisement periods set for the advertisement.

More particularly, the registration amount for the advertisement can be determined as a value obtained by multiplying the advertisement quantity set for the advertisement by the advertisement provision frequency for respective advertisement periods set for the advertisement.

In more detail, the registration amount acknowledgment unit 130 acknowledges the advertisement which is requested to be registered. In the following, the advertisement 1 is acknowledged to be requested to be registered for the convenience of explanation.

For example, the registration amount acknowledgment unit 130 can receive the request for registration of the advertisement from the advertiser 200 mentioned above in FIG. 1.

Here, when the registration amount acknowledgment unit 130 receives the request for registration of advertisement 1 from the advertiser 200, the registration amount acknowledgment unit can acknowledge, for the advertisement 1, the advertisement 1, the advertisement amount (e.g.: 10) set for the advertisement 1, and an advertisement provision frequency (e.g.: once) for an advertisement period (e.g.: 1 day) set for the advertisement 1.

Then, when the registration for the advertisement 1 is requested from the advertiser 200 as above, the acknowledged advertisement 1 can be stored in the advertisement storage unit 110 of the advertisement providing apparatus 100.

And, the registration amount acknowledgment unit 130 can determine/acknowledge the value (e.g.: 10), which is obtained by multiplying the acknowledged advertisement amount (e.g. 10) set for the advertisement 1 by the advertisement provision frequency (e.g.: once) for an advertisement period (e.g.: 1 day) set for the advertisement 1, as the registration amount for the advertisement 1.

The advertisement registration unit 140 registers, for each of a specific number of terminals according to the registration amount (e.g.: 10) acknowledged in the registration amount acknowledgment unit 130 among the plurality of terminals (terminal 1, terminal 2, terminal 3 . . . terminal N) where at least two applications, which are registration targets for the advertisement 1, are respectively installed, the advertisement for one application of at least two applications.

Here, as mentioned above in the description related to FIG. 1, it is assumed that application 1 (App1, hereinunder), application 2 (App2, hereinunder), application 4 (App4, hereinunder) . . . are installed on terminal 1, App1 and application 3 (App3, hereinunder) are installed on terminal 2, and App1, App2, App3 . . . are installed on terminal 3 for the convenience of explanation.

In more detail, the advertisement registration unit 140 acknowledges the specific number of terminals according to the registration amount (e.g.: 10) acknowledged in the registration amount acknowledgment unit 130 among a plurality of terminals (terminal 1, terminal 2, terminal 3 . . .terminal N).

Then, the advertisement registration unit 140 registers the advertisement only for one application of the at least two applications installed on the corresponding terminal, for each of the acknowledged specific number (e.g.: 10) of terminals.

For example, in case of the first embodiment, the advertisement providing apparatus 100 according to the present invention maintains a database (DB) of information on which application is installed on the respective terminals, for the plurality of terminals (terminal 1, terminal 2, terminal 3 . . . terminal N) on which the at least two applications, which are registration targets for the advertisement, are installed.

Therefore, the advertisement registration unit 140 acknowledges the specific number of terminals according to the registration amount (e.g.: 10) acknowledged for advertisement 1 among the plurality of terminals (terminal 1, terminal 2, terminal 3 . . . terminal N) based on the aforementioned database (DB), when the registration amount (e.g.: 10) is acknowledged for advertisement 1 in the registration amount acknowledgment unit 130.

Then, the advertisement registration unit 140 can register the advertisement only for one application of the at least two applications installed on the corresponding terminal, for each of the acknowledged specific number (e.g.: 10) of terminals based on the aforementioned database (DB).

Therefore, by performing the advertisement registration process based on the aforementioned database (DB), the advertisement registration unit 140 registers, when at least two applications, which are registration targets for the advertisement 1, are installed on each of the acknowledged specific number (e.g.: 10) of terminals, the advertisement for the application as the population parameter such that the same advertisement is not provided to one terminal more than once by registering the advertisement 1 for only one application of the at least two applications installed on the corresponding terminal for each of the specific number (e.g.: 10) of terminals.

Meanwhile, when the advertisement registration process is performed based on the database (DB) as in the aforementioned first embodiment, the performance of the advertisement registration process can be complex and a process time can be increased due to properties of the database (DB), as the registration amount (e.g.: 20,000) increases.

Therefore, according to the present invention, there is further proposed a method of registering the advertisement for the application as the population parameter while preventing the same advertisement from being provided to one terminal by performing the advertisement registration process using a linked list structure.

To describe a second embodiment for accomplishing above, the advertisement providing apparatus 100 according to the present invention can further include a linked list storage unit 120.

The linked list storage unit 120 stores a terminal information linked list in which respective pieces of terminal information on a plurality of terminals (terminal 1, terminal 2, terminal 3. . . terminal N) are listed.

Furthermore, the linked list storage unit 120 can store, for each of the plurality of terminals (terminal 1, terminal 2, terminal 3 . . . terminal N), an application information linked list in which application information on each of the at least two applications installed on the corresponding terminal is listed.

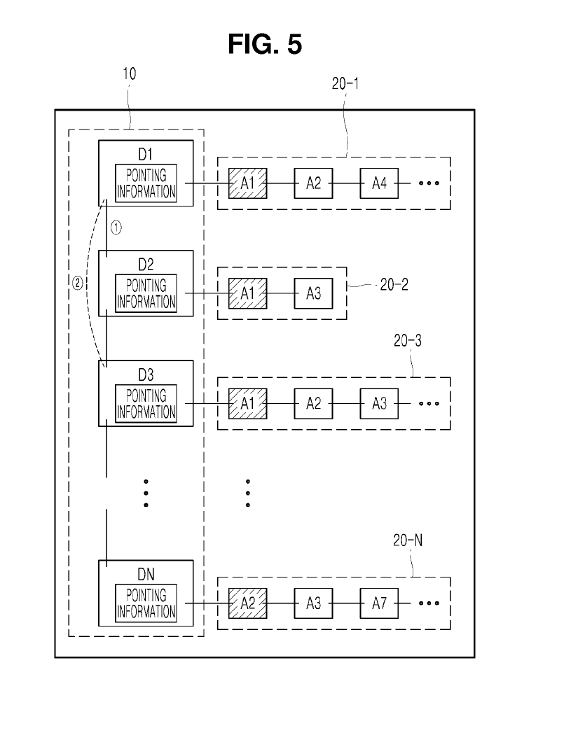

Here, by referring to FIG. 5 which depicts the data structure based on the aforementioned terminal information linked list and the application information linked list, as shown in FIG. 5, a terminal information linked list 10, in which the respective terminal information on the plurality of terminals (terminal 1, terminal 2, terminal 3 . . . terminal N) is listed, and application information linked lists 20-1, 20-2, 20-3 . . . 20-N, in which the application information on each of the at least two applications installed on the corresponding terminal are listed for each of the plurality of terminals (terminal 1, terminal 2, terminal 3 . . .terminal N), can be stored in the linked list storage unit 120.

Therefore, when the terminal information D1 on the terminal 1 is described among the respective terminal information listed in the terminal information linked list 10, it is as follows.

In the terminal information D1 on the terminal 1, a terminal ID of the terminal 1, next terminal information (e.g.: D2) listed next in the terminal information linked list 10, application information (A1 of App1) listed first application information linked list 20-1 as link information for linking the terminal information D1 with the application information linked list 20-1 of the terminal 1, pointing information pointing to application information (e.g.: A2 of App2) which is listed first in the application information linked list 20-1 on an application for which no advertisement is registered, and number information on remaining pieces of application information in the application information linked list 20-1on applications for which no advertisement is registered can be included.

And, to application information (A1) of App1 among the respective application information listed in the application information linked list 20-1 is described as follows.

An App ID of App1, flag information representing whether the advertisement is registered, next application information (e.g.: A2) listed next in the application information linked list 20-1 can be included in the application information (A1) of App1 .

Therefore, the advertisement registration unit 140 can sequentially acknowledge the specific number (e.g.: 10) of pieces of terminal information according to the registration amount (e.g.: 10) in a forward sequence (D1->D2-> . . . ->DN) from first terminal information (D1) listed in the terminal information linked list (10) or sequentially acknowledge the specific number (e.g.: 10) of pieces of terminal information according to the registration amount (e.g.: 10) in a reverse sequence (DN->DN-1 . . . ->D1) from latest listed terminal information (DN), such that the specific number (e.g.: 10) of terminals are acknowledged among the plurality of terminals (terminal 1, terminal 2, terminal 3 . . . terminal N).

In the meantime, the advertisement registration unit 140 can register the advertisement 1 for the one application according to the pointing information for the respective terminal information which are sequentially acknowledged while the specific number (e.g.: 10) of pieces of terminal information are acknowledged in the terminal information linked list 10 as mentioned above.

That is, the advertisement registration unit 140 can sequentially register all of the registration amount (e.g.: 10) of the advertisement 1 for the one application on the respective terminals while acknowledging the specific number (e.g.: 10) of pieces of terminal information in the terminal information linked list 10 by registering the advertisement 1 for the application, for which no advertisement is registered, corresponding to the application information listed first, that is, the application information which is pointed by the pointing information included in the acknowledged terminal information, every time when the terminal information is acknowledged one by one in the terminal information linked list 10 as mentioned above.

Therefore, when the advertisement registration process is performed by utilizing the terminal information linked list 10 and the application information linked list 20-1, 20-2, 20-3 . . . 20-N having linked list structures as in the aforementioned second embodiment, the problem of the first embodiment can be solved by sequentially registering all advertisements for the one application on each of the terminals while simply performing a process of acknowledging the specific number (e.g.: 20,000) of pieces of terminal information according to the registration amount (e.g.: 20,000) in the terminal information linked list, even when the registration amount (e.g.: 20,000) of the advertisements increases.

Meanwhile, although only a case in which one advertisement is requested to be registered is described in the above, there can be more than one advertisement that is requested to be registered.

For example, when there are more than one advertisement requested to be registered, for example when registration for a first advertisement (advertisement 1, hereinunder) and a second advertisement (advertisement 2, hereinunder) are requested, the advertisement registration unit 140 can sequentially perform the advertisement registration process for the advertisement 1 and the advertisement 2.

That is, the advertisement registration unit 140 performs the advertisement registration process for the advertisement 1 by utilizing the terminal information linked list 10 and the application information linked list 20-1, 20-1, 20-2, 20-3 . . . 20-N after acknowledging the registration amount as mentioned above, and then performs the advertisement registration process for the advertisement 2 by utilizing the terminal information linked list 10 and the application information linked list 20-1, 20-1, 20-2, 20-3 . . . 20-N after acknowledging the registration amount as mentioned above.

In the meantime, in acknowledging the specific number of terminals according to the registration amount of the advertisements by using one of the forward sequence and the reverse sequence based on the terminal information linked list 10 for the advertisements, the advertisement registration unit 140 can use for the advertisement 1 one of the forward sequence and the reverse sequence and the other one different from the one for the advertisement 1 for the advertisement 2.

That is, the advertisement registration unit 140 acknowledges the specific number of terminals according to the registration amount of the advertisement 1 by using one (e.g.: forward sequence) of the forward sequence and the reverse sequence based on the terminal information linked list 10 for the advertisement 1, and then acknowledges the specific number of terminals according to the registration amount of the advertisement 2 by using the other one (e.g.: reverse sequence) different from the one for the advertisement 1 based on the terminal information linked list 10.

Similarly, by alternating the forward sequence and the reverse sequence sequentially in acknowledging the specific number of terminals according to the registration amount of the advertisements by using one of the forward sequence and the reverse sequence based on the terminal information linked list 10 for the advertisements, the advertisements can be registered for more dispersed terminals than using only one sequence.

Therefore, by registering the advertisement 1 for only one application for each of the specific number (e.g.: 10) of terminals according to the registration amount (e.g.: 10) for the advertisement 1, the advertisement 1 can be registered for the respective applications, which are population parameters installed on different terminals without duplication.

The advertisement providing apparatus 150 can expose the advertisement 1 on only one application installed on each of the specific number (e.g.: 10) of terminals by providing the advertisement 1 to the respective applications according to the registration result of the advertisement registration unit 140.

That is, the advertisement providing apparatus 150 can provide the advertisement 1 to the respective applications according to the registration result when an advertisement provision event for the advertisement 1 occurs after registering the advertisement 1 for the respective applications as population parameters installed on different terminals without duplication, as described above.

In the meantime, the advertisement providing unit 150 can provide the advertisement 1 to the respective applications by using various conventional push type providing methods.

Therefore, the advertisement 1 is exposed through the corresponding applications on the specific number (e.g.: 10) of terminals where the one application, which has received advertisement 1 provided from the advertisement providing apparatus 100, is installed among the plurality of terminals, that is, terminal 1, terminal 2, terminal 3 . . . terminal N.

As described above, the advertisement providing apparatus according to the present invention registers the advertisements in such a way that the same advertisement is not provided to one terminal multiple times during the advertisement registration process during which the advertisements are registered for the applications as population parameters, and, therefore, when the advertisements are provided according to a registration result, can yield an effect that the advertisement service is provided such that the same advertisement is not provided more than once even when more than one application, which is treated as the same population parameter, is installed on one terminal.

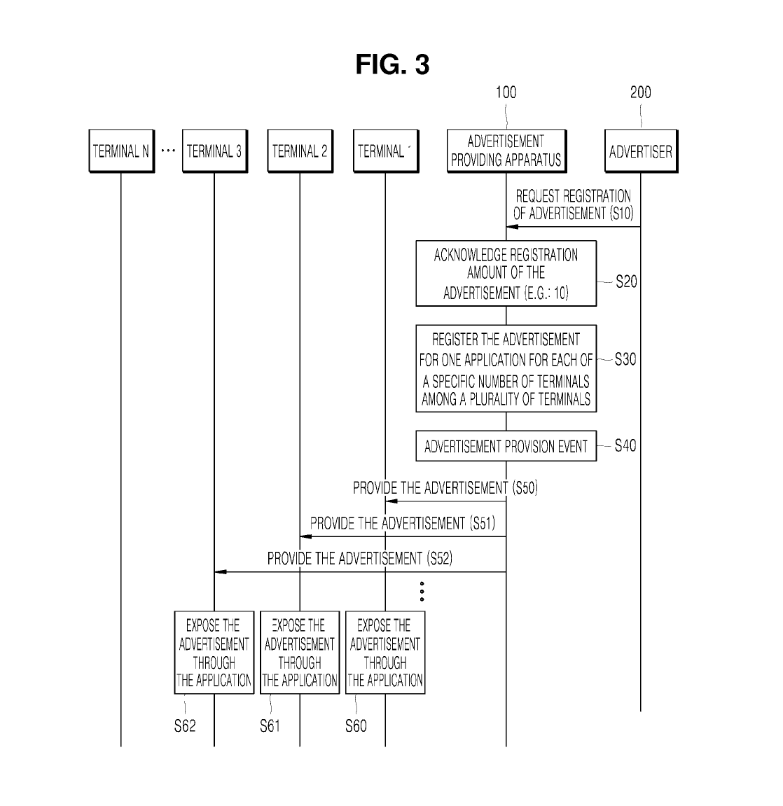

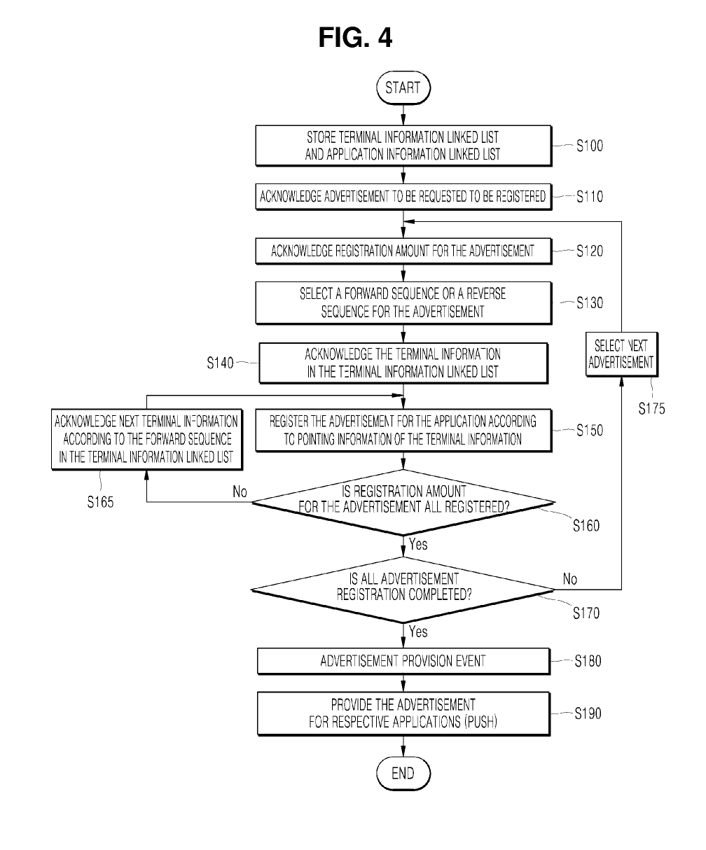

In the following, an advertisement service method and an operation method for an advertisement providing apparatus according to an embodiment of the present invention are described by referring to FIG. 3 and FIG. 4. References to the references numerals in aforementioned FIG. 1 and FIG. 2 are made for the convenience of explanation.

First, a control flow of the advertisement service method according to the present invention is described by referring to FIG. 3.

The advertisement providing apparatus 100 can receive a request for registration of advertisements from the advertiser 200 (S10). In the following, the description will refer to the advertisement 1 which is requested to be registered for the convenience of explanation.

Therefore, the advertisement providing apparatus 100 acknowledges the registration amount for the advertisement 1, that is, the application for the registration request, when the registration request is received from the advertiser 200 (S20).

Then, the advertisement providing apparatus 100 registers, for each of a specific number of terminals according to the acknowledged registration amount among a plurality of terminals (terminal 1, terminal 2, terminal 3 . . . terminal N) where at least two applications, which are registration targets for the advertisement 1, are respectively installed, the advertisement for one application of at least two applications (S30).

That is, the advertisement providing apparatus 100 acknowledges the specific number (e.g.: 10) of terminals according to the acknowledged registration amount among the terminals (terminal 1, terminal 2, terminal 3 . . . terminal N) where at least two applications, which are registration targets for the advertisement 1, are respectively installed.

And, the advertisement providing apparatus 100 registers the advertisement only for one application of the at least two applications installed on the terminal, for each of the acknowledged specific number of (e.g.: 10) terminals.

Then, the advertisement providing apparatus 100 can provide (S50,S51,S52 . . . ) the advertisement 1 to respective applications according to the registration result when an advertisement provision event for the advertisement 1 occurs (S40) after the advertisement 1 is registered for the respective applications as population parameters, as described above.

Therefore, the advertisement 1 is exposed through the corresponding applications on the specific number (e.g.: 10) of terminals where the one application, which has received advertisement 1 provided from the advertisement providing apparatus 100, is installed among the plurality of terminals, that is, terminal 1, terminal 2, terminal 3 . . . terminal N (S60,S61,S62 . . . ).

As a result, by using the advertisement service method according to the present invention, the advertisement 1 is registered for only one application on each of the specific number (e.g.: 10) of terminals according to the registration amount (e.g.: 10) for the advertisement 1, and the advertisement 1 is provided according to the registration result, thereby preventing the same advertisement from being provided to one terminal more than once in providing the advertisement service, as described above.

In the following, the operation method for the advertisement providing apparatus according to one embodiment of the present invention is described in more detail by referring to FIG. 4.

In the operation method for the advertisement providing apparatus according to present invention, a terminal information linked list in which respective terminal information on a plurality of terminals (terminal 1, terminal 2, terminal 3 . . . terminal N) is listed is stored (S100).

Furthermore, in the operation method for the advertisement providing apparatus according to the present invention, application information linked lists in which application information on each of at least two application installed on a corresponding terminal can be stored for each of the plurality of terminals (terminal 1, terminal 2, terminal 3 . . . terminal N) (S100).

Here, by referring to FIG. 5, in the operation method for the advertisement providing apparatus according to the present invention as shown in FIG. 5, a terminal information linked list 10, in which the respective terminal information on the plurality of terminals (terminal 1, terminal 2, terminal 3 . . . terminal N) is listed, and application information linked lists 20-1, 20-2, 20-3 . . . 20-N, in which the application information on each of the at least two applications installed on the corresponding terminal are listed for each of the plurality of terminals (terminal 1, terminal 2, terminal 3 . . . terminal N), can be stored.

Therefore, when the terminal information D1 on the terminal 1 is described among the respective terminal information listed in the terminal information linked list 10, it is as follows.

In the terminal information D1 on the terminal 1, a terminal ID of the terminal 1, next terminal information (e.g.: D2) listed next in the terminal information linked list 10, application information (A1 of App1) listed first application information linked list 20-1 as link information for linking the terminal information D1 with the application information linked list 20-1 of the terminal 1, pointing information pointing to application information (e.g.: A2 of App2) which is listed first in the application information linked list 20-1 on an application for which no advertisement is registered, and number information on remaining pieces of application information in the application information linked list 20-1 on applications for which no advertisement is registered can be included.

And, to application information (A1) of App1 among the respective application information listed in the application information linked list 20-1 is described as follows.

An App ID of App1, flag information representing whether the advertisement is registered, next application information (e.g.: A2) listed next in the application information linked list 20-1 can be included in the application information (A1) of App1.

In the operation method for the advertisement providing apparatus according to the present invention, the registration amount for the advertisement which is requested to be registered is acknowledged.

Here, the registration amount for the advertisement can be determined based on an advertisement quantity set for the advertisement and an advertisement provision frequency for respective advertisement periods set for the advertisement.

In more detail, in the operation method for the advertisement providing apparatus according to the present invention, the advertisement which is requested to be registered is acknowledged (S110). In the following the advertisement 1 is acknowledged to be requested to be registered for the convenience of explanation.

For example, in the operation method for the advertisement providing apparatus according to the present invention, the request for registration can be received from the advertiser 200 mentioned in FIG. 1.

Here, in the operation method for the advertisement providing apparatus according to the present invention, when the request for registration of advertisement 1 from the advertiser 200 is received, the advertisement 1, the advertisement amount (e.g.: 10) set for the advertisement 1, and an advertisement provision frequency (e.g.: once) for an advertisement period (e.g.: 1 day) set for the advertisement 1 can be acknowledged for the advertisement 1 from the advertiser 200.

Here, in the operation method for the advertisement providing apparatus according to the present invention, the advertisement 1 is stored which is acknowledged when the request for registration of advertisement 1 from the advertiser 200 is received, and a value obtained by multiplying the advertisement amount (e.g.: 10) set for the advertisement 1 and acknowledged for the advertisement 1 by an advertisement provision frequency (e.g.: once) for an advertisement period (e.g.: 1 day) set for the advertisement 1 can be determined/acknowledged for the advertisement 1 as the registration amount for the advertisement 1 (S120).

And, in the operation method for the advertisement providing apparatus according to the present invention, the advertisements are registered, for each of a specific number (e.g.: 10) of terminals according to the registration amount acknowledged in S120 among the plurality of terminals (terminal 1, terminal 2, terminal 3 . . . terminal N) where at least two applications, which are registration targets for the advertisement 1, are respectively installed, for one application of at least two applications.

Here, as mentioned above in the description related to FIG. 1, it is assumed that application 1 (App1, hereinunder), application 2 (App2, hereinunder), application 4 (App4, hereinunder) . . . are installed on terminal 1, App1 and application 3 (App3, hereinunder) are installed on terminal 2, and App1, App2, App3 . . . are installed on terminal 3 for convenience of explanation.

In more detail, in the operation method for the advertisement providing apparatus according to the present invention, one of a forward sequence or a reverse sequence is selected for the advertisement 1 (S130). The forward sequence will be described as an example.

Of course, one of the forward sequence and the reverse sequence can also be preselected in the operation method for the advertisement providing apparatus according to the present invention without requiring a separate selection step such as S130.

And, when the forward sequence is selected, in the operation method for the advertisement providing apparatus according to the present invention, a specific number (e.g.:10) of pieces of terminal information according to the registration amount (e.g.: 10) are sequentially acknowledged according to the forward sequence (D1->D2-> . . . ->DN) from the terminal information (D1) which is listed first in the terminal information linked list 10.

In more detail, in the operation method for the advertisement providing apparatus according to the present invention, the terminal information (D1) which is listed first is acknowledged during a process of acknowledging the specific number (e.g.: 10) of pieces of terminal information in the terminal information linked list 10 (S140).

Therefore, in the operation method for the advertisement providing apparatus according to the present invention, the pointing information of the acknowledged terminal information (D1) is acknowledged, and the advertisement 1 is registered for the App2 of the application information (e.g.: A2) which is listed first in the application information linked list 20-1 and related to an application for which the advertisement pointed by the pointing information is not registered (S150).

And, in the operation method for the advertisement providing apparatus according to the present invention, whether the registration amount (e.g.: 10) of advertisement 1 is all registered is determined (S160), and when no, next listed terminal information (D2) will be acknowledged according to a process of acknowledging the specific number (e.g.: 10) of pieces of terminal information in the terminal information linked list 10 in the forward sequence (S165).

Next, in the operation method for the advertisement providing apparatus according to the present invention, it proceeds to S150 to acknowledge the pointing information of the terminal information (D1) acknowledged in S165, and the advertisement 1 is registered for the App3 of the application information (e.g.: A3) which is listed first in the application information linked list 20-2 and related to an application for which the advertisement pointed by the pointing information is not registered (S150).

In the meantime, as also known from FIG. 5, there will be no remaining application information which is not registered for the terminal 2 after the advertisement 1 is registered for the App3 of the application information (e.g.: App3) in the application information linked list 20-2. That is, the number information of the application information of the terminal information (D1) come to 0.

In this case, as shown in FIG. 5, the terminal information linked list 10 can be managed in such a way that the next terminal information included in the terminal information (D1) in the terminal information linked list 10 is amended from D2 to D3, such that the terminal information (D2) is removed from the terminal information linked list 10.

Then, a link relation among D1, D2, and D3 in the terminal information linked list 10 is changed from \textcircled{1} to \textcircled{2} as shown in FIG. 5, then the order of the terminal information listed in the terminal information linked list 10 will come to D1->D3->D4 . . . ->DN.

And, in the operation method for the advertisement providing apparatus according to the present invention, it proceeds to S160 to determine again whether the registration amount (e.g.: 10) of advertisement 1 is all registered, and when no, it proceeds to S165 to acknowledge next listed terminal information (D3) according to a process of acknowledging the specific number (e.g.: 10) of pieces of terminal information in the terminal information linked list 10 in the forward sequence.

Similarly, in the operation method for the advertisement providing apparatus according to the present invention, steps S150, S165, S165 are repeatedly performed, such that a specific number (e.g.: 10) of pieces of terminal information according to the registration amount (e.g.: 10) are sequentially acknowledged in the forward sequence (D1->D2-> . . . ->DN) from the terminal information (D1) which is listed first in the terminal information linked list 10, and then the advertisement 1 is sequentially registered for the application of related to the application information pointed by the pointing information included in the acknowledged terminal information, whenever the terminal information is acknowledged one by one in the terminal information linked list 10 as mentioned above.

Here, in the operation method for the advertisement providing apparatus according to the present invention, when it is determined that the registration amount (e.g.: 10) for the advertisement 1 is all registered in step S160 (“YES” in S160) it is determined whether the registration is completed for all advertisements which are requested to be registered (S170).

For example, when the advertisement which is requested to be registered is one as above, in the operation method for the advertisement providing apparatus according to the present invention, it can be determined that the registration is completed for all advertisements which are requested to be registered in step S170 (“YES” in S170).

On the other hand, when the advertisements which are requested to be registered are, for example, advertisement 1 and advertisement 2, in the operation method for the advertisement providing apparatus according to the present invention, it is determined in step S170 that the registration is not completed for all advertisements which are requested to be registered (“NO” in S170).

In this case, in the operation method for the advertisement providing apparatus according to the present invention, since the registration amount (e.g.: 10) for the advertisement 1 is all registered for the advertisement 1, step S120 is performed for the next advertisement, that is, the advertisement 2 which is requested to be registered to acknowledge the registration amount for the advertisement 2.

For example, in the operation method for the advertisement providing apparatus according to the present invention, when the request for registration of advertisement 2 from the advertiser 200 is received, the advertisement 2, the advertisement amount (e.g.: 5) set for the advertisement 2, and an advertisement provision frequency (e.g.: 3) for an advertisement period (e.g.: 1 day) set for the advertisement 2 can be acknowledged for the advertisement 2 from the advertiser 200.

Here, in the operation method for the advertisement providing apparatus according to the present invention, the advertisement 2 is stored which is acknowledged when the request for registration of advertisement 2 from the advertiser 200 is received, and a value obtained by multiplying the advertisement amount (e.g.: 5) set for the advertisement 2 and acknowledged for the advertisement 2 by an advertisement provision frequency (e.g.: 3) for an advertisement period (e.g.: 1 day) set for the advertisement 2 can be determined/acknowledged for the advertisement 2 as the registration amount for the advertisement 2 (S120).

Then, in the operation method for the advertisement providing apparatus according to the present invention, one of a forward sequence or a reverse sequence is selected for the advertisement 2 to be different from the one for the advertisement 1 (S130). For example, since the forward sequence was selected for the advertisement 1, the reverse sequence can be selected for the advertisement 2.

Of course, one of the forward sequence and the reverse sequence can also be preselected in the operation method for the advertisement providing apparatus according to the present invention without requiring a separate selection step such as S130.

And, when the reverse sequence is selected, in the operation method for the advertisement providing apparatus according to the present invention, a specific number (e.g.: 15) of pieces of terminal information according to the registration amount (e.g.: 15) are sequentially acknowledged according to the reverse sequence (DN->DN-1-> . . . ->D1) from the terminal information (DN) which is listed last in the terminal information linked list 10.

In more detail, in the operation method for the advertisement providing apparatus according to the present invention, the terminal information (DN) which is listed last is acknowledged during a process of acknowledging the specific number (e.g.: 10) of pieces of terminal information in the terminal information linked list 15 (S140).

Therefore, in the operation method for the advertisement providing apparatus according to the present invention, the pointing information of the acknowledged terminal information (DN) is acknowledged, and the advertisement 2 is registered for the App3 of the application information (e.g.: A3) which is listed last in the application information linked list 20-N and related to an application for which the advertisement pointed by the pointing information is not registered (S150).

And, in the operation method for the advertisement providing apparatus according to the present invention, whether the registration amount (e.g.: 15) of advertisement 2 is all registered is determined (S160), and when no, next listed terminal information (DN-1) will be acknowledged according to a process of acknowledging the specific number (e.g.: 15) of pieces of terminal information in the terminal information linked list 10 in reverse forward sequence (S165).

Next, in the operation method for the advertisement providing apparatus according to the present invention, it proceeds to S150 to acknowledge the pointing information of the terminal information (DN-1) acknowledged in S165, and the advertisement 2 is registered for the App of the application information which is listed first in the application information linked list 20-N-1 and related to an application for which the advertisement pointed by the pointing information is not registered (S150).

And, in the operation method for the advertisement providing apparatus according to the present invention, it proceeds to S160 to determine again whether the registration amount (e.g.: 15) of advertisement 2 is all registered, and when no, it proceeds to S165 to acknowledge next listed terminal information (DN-3) according to a process of acknowledging the specific number (e.g.: 15) of pieces of terminal information in the terminal information linked list 10 in the reverse sequence.

Similarly, in the operation method for the advertisement providing apparatus according to the present invention, steps S150, S165, S165 are repeatedly performed, such that a specific number (e.g.: 15) of pieces of terminal information according to the registration amount (e.g.: 15) are sequentially acknowledged in the reverse sequence (DN->DN-1-> . . . ->D1) from the terminal information (DN) which is listed last in the terminal information linked list 10, and then the advertisement 2 is sequentially registered for the application of related to the application information pointed by the pointing information included in the acknowledged terminal information, whenever the terminal information is acknowledged one by one in the terminal information linked list 10 as mentioned above.

Here, in the operation method for the advertisement providing apparatus according to the present invention, when it is determined that the registration amount (e.g.: 15) for the advertisement 2 is all registered in step S160 (“YES” in S160) it is determined whether the registration is completed for all advertisements which are requested to be registered (S170).

Here, wince the registration is completed for the advertisement 1 and the advertisement 2 which are requested to be registered, in the operation method for the advertisement providing apparatus according to the present invention, it can be determined that the registration is completed for all advertisements which are requested to be registered in step S170 (“YES” in S170).

Similarly, in the operation method for the advertisement providing apparatus according to the present invention, the advertisement can be registered for the respective applications, which are population parameters installed on different terminals without duplication by registering the advertisement for only one application for each of the specific number (e.g.: 10) of terminals according to the registration amount (e.g.: 10) for the advertisement.

Then, in the operation method for the advertisement providing apparatus according to the present invention, when an advertisement provision event occurs (S180) for the advertisement 1, the advertisement 1 is provided to the respective applications according to the aforementioned registration result, thereby exposing the advertisement 1 on only one application installed on each of the specific number (e.g.: 10) of terminals.

That is, in the operation method for the advertisement providing apparatus according to the present invention, the advertisement 1 can be provided to the respective applications according to the registration result when an advertisement provision event for the advertisement 1 occurs after registering the advertisement 1 for the respective applications as population parameters installed on different terminals without duplication, as described above.

In the meantime, in the operation method for the advertisement providing apparatus according to the present invention, the advertisement 1 can be provided to the respective applications by using various conventional push type providing methods.

Therefore, the advertisement 1 is exposed through the corresponding applications on the specific number (e.g.: 10) of terminals where the one application, which has received advertisement 1 provided from the advertisement providing apparatus 100, is installed among the plurality of terminals, that is, terminal 1, terminal 2, terminal 3 . . . terminal N.

As described above, the advertisement service method and the operation method for the advertisement providing apparatus according to the present invention register the advertisements in such a way that the same advertisement is not provided to one terminal multiple times during the advertisement registration process during which the advertisements are registered for the applications as population parameters, and, therefore, when the advertisements are provided according to a registration result, can yield an effect that the advertisement service is provided such that the same advertisement is not provided more than once even when more than one application, which is treated as the same population parameter, is installed on one terminal.

The advertisement service method and the operation method for the advertisement providing apparatus according to the present invention can be embodied as program instructions executable by various computer means and recorded on a computer-readable medium. The computer-readable medium can include program instructions, data files, data structures, etc. exclusively or in combination. The program instructions recorded on the medium can be specifically designed and configured for the present invention or well known to be available by a skilled artisan in computer software. In the example of the computer-readable recording medium, magnetic media such as hard disks, floppy disks, and magnetic tapes, optical media such as digital versatile disks (DVDs), magneto-optical media such as floptical disks, and hardware devices specially configured to store and execute program instructions such as ROMs, RAMs, and flash memories, etc. are included. In the example of the computer instructions, machine language codes created by a compiler as well as a high level language code executable by a computer using an interpreter, etc. are included. The hardware device can be configured to operate as one or more software module for performing the operations of the present invention, and vice versa.

Although the present invention is explained in detail by referring to preferred embodiments, the present invention is not restricted to the above embodiments, and the technical scope of the present invention encompass the range where a person with an ordinary skill in the relevant art can readily vary or modify without deviating from the subject matter as claimed in claims.

### INDUSTRIAL APPLICABILITY

According to the advertisement providing system, the method therefor, and the apparatus applied to the same according to the present invention, limits of the prior art are overcome in that the same advertisement is not provided to one terminal more than once, which not only enables the applied apparatus to be used for related arts but also empowers the applied apparatus with high marketability, and definitely substantiates the industrial applicability of the present invention.

1. An advertisement providing apparatus characterized in comprising:
a registration amount acknowledgment unit which acknowledges a registration amount for an advertisement which is requested to be registered;
an advertisement registration unit which, for each of a specific number of terminals according to the registration amount among a plurality of terminals where at least two applications, which are registration targets for the advertisement, are respectively installed, registers the advertisement for one application of the at least two applications; and
an advertisement providing unit which provides the advertisement to respective applications according to a registration result of the advertisement registration unit, such that the advertisement can be exposed on only one of the applications which are installed on each of the specific number of terminals.

2. The advertisement providing apparatus according to claim 1, characterized in that the registration amount for the advertisement is determined based on an advertisement quantity set for the advertisement and an advertisement provision frequency for respective advertisement periods set for the advertisement.

3. The advertisement providing apparatus according to claim 1, characterized in that the advertisement registration unit acknowledges the specific number of terminals according to the registration amount among the plurality of terminals, and, for each of the specific number of acknowledged terminals, registers the advertisement for one application, for which no advertisement is registered, among the at least two applications installed on the terminal.

4. An advertisement providing apparatus characterized in comprising:
a registration amount acknowledgment unit which acknowledges a registration amount for an advertisement which is requested to be registered;
a linked list storage unit which stores a terminal information linked list in which respective terminal information on each of a plurality of terminals is listed; and
an advertisement registration unit which acknowledges a specific number of terminals according to the registration amount among a plurality of terminals where at least two applications, which are registration targets for the advertisement, are respectively installed, and, for each of the specific number of acknowledged terminals, registers the advertisement for one application, for which no advertisement is registered, among the at least two applications installed on the terminal,
wherein the advertisement registration unit sequentially acknowledges the specific number of pieces of terminal information according to the registration amount in a forward sequence from first terminal information listed in the terminal information linked list or sequentially acknowledges the specific number of pieces of terminal information according to the registration amount in a reverse sequence from latest listed terminal information, such that the specific number of terminals are acknowledged among the plurality of terminals.

5. The advertisement providing apparatus according to claim 4, characterized in that:
the respective terminal information includes pointing information which points to one application, for which no advertisement is registered, among the at least two applications installed on the corresponding terminal, and
the advertisement registration unit registers the advertisement for the one application according to the pointing information of the respective sequentially-acknowledged terminal information while acknowledging the specific number of pieces of terminal information in the terminal information linked list.

6. The advertisement providing apparatus according to claim 4 characterized in that:
the advertisement which is requested to be registered includes a first advertisement and a second advertisement, and
the advertisement registration unit, for the first advertisement, acknowledges the specific number of the terminals according to the registration amount of the first advertisement by using one of the forward sequence and the reverse sequence based on the terminal information linked list, and, for the second advertisement, acknowledges the specific number of the terminals according to the registration amount of the second advertisement by using the other of the forward sequence and the reverse sequence different from the one for the first advertisement based on the terminal information linked list.

7. The advertisement providing apparatus according to claim 5 characterized in that:
the linked list storage unit, for each of the plurality of terminals, registers an application information linked list in which application information on each of the at least two applications installed on the corresponding terminal is listed, and
the pointing information included in the terminal information of a specific terminal among the plurality of terminals points to application information on an application for which no advertisement is registered and which is listed first in the application information linked list for the specific terminal.

8. An advertisement providing method characterized in comprising:
a step in which an advertisement providing apparatus acknowledges a registration amount for an advertisement which is requested to be registered;
a step in which the advertisement providing apparatus, for each of a specific number of terminals according to the registration amount among a plurality of terminals where at least two applications, which are registration targets for the advertisement, are respectively installed, registers the advertisement for one application of the at least two applications;
a step in which the advertisement providing apparatus provides the advertisement to respective applications according to a registration result; and
a step in which the one application, which is installed on each of the specific number of terminals, exposes the provided advertisement.

9. An operation method for an advertisement providing apparatus characterized in comprising:
a registration amount acknowledgment step in which a registration amount for an advertisement which is requested to be registered is acknowledged;
an advertisement registration step in which, for each of a specific number of terminals according to the registration amount among a plurality of terminals where at least two applications, which are registration targets for the advertisement, are respectively installed, the advertisement is registered for one application of the at least two applications; and
an advertisement providing step in which the advertisement is provided to respective applications according to a registration result of the advertisement registration step, such that the advertisement can be exposed on only one of the applications which are installed on each of the specific number of terminals.

10. The operation method for an advertisement providing apparatus according to claim 9, characterized in that the advertisement registration step includes:
a first step in which the specific number of terminals are acknowledged among the plurality of terminals according to the registration amount; and
a second step in which, for each of the specific number of acknowledged terminals, the advertisement is registered for one application, for which no advertisement is registered, among the at least two applications installed on the terminal.

11. The operation method for an advertisement providing apparatus according to claim 10, characterized in that:
the method further comprises a step in which a terminal information linked list in which respective terminal information on each of a plurality of terminals is listed is stored;
and in the first step, the specific number of pieces of terminal information according to the registration amount in a forward sequence from first terminal information listed in the terminal information linked list are sequentially acknowledged or the specific number of pieces of terminal information according to the registration amount in a reverse sequence from latest listed terminal information are sequentially acknowledged, such that the specific number of terminals are acknowledged among the plurality of terminals.

12. The operation method for an advertisement providing apparatus according to claim 10, characterized in that:
the method further comprises a step in which a terminal information linked list in which respective terminal information on each of the plurality of terminals is listed and, for each of the plurality of terminals, an application information linked list in which application information on each of the at least two applications installed on the corresponding terminal is listed are stored, wherein the respective terminal information includes pointing information pointing to application information on an application for which no advertisement is registered and which is listed first in the application information linked list for the specific terminal; and
in the second step,
the advertisement is registered for the one application according to the pointing information of the respective terminal information which is sequentially acknowledged in the first step while sequentially acknowledging the specific number of pieces of terminal information from the terminal information linked list.

13. An advertisement service system characterized in comprising:
an advertisement providing apparatus which acknowledges a registration amount for an advertisement which is requested to be registered, registers, for each of a specific number of terminals according to the registration amount among a plurality of terminals where at least two applications, which are registration targets for the advertisement, are respectively installed, for one application of at least two applications, and provides the advertisement to the respective applications according to a registration result; and
a terminal on which the at least two applications are installed and which exposes the advertisement provided from the advertisement providing apparatus through the one application of the at least two applications.
